(19) United States
(12) Patent Application Publication
(10) Pub. No.: US 2014/0149230 A1
(43) Pub. Date: May 29, 2014

(54) PROGRAMMATIC BUYING OF ONLINE DISPLAY ADVERTISEMENTS

(71) Applicant: MICROSOFT CORPORATION, Redmond, WA (US)

(72) Inventors: MARC SHEPARD, Bellevue, WA (US); Julianne Marie Parsons, Mercer Island, WA (US); Steve Guidi, Kirkland, WA (US); Fang Wang, Redmond, WA (US); Bashar Kachachi, Kirkland, WA (US)

(73) Assignee: Microsoft Corporation, Redmond, WA (US)

(21) Appl. No.: 13/688,547

(22) Filed: Nov. 29, 2012

(51) Int. Cl. G06Q 30/02

(52) U.S. Cl. CPC G06Q 30/0273
USPC 705/14.69

(57) ABSTRACT

Systems, media, and methods are provided to select advertisements for available impressions associated with a publisher's impression inventory. The selected advertisements may correspond to advertisement campaigns managed by buyers that seek to promote goods or services on web pages or media. The advertisement campaign is generated via an interface that receives a request for reserved or non-reserved portions of the publisher's impression inventory. The advertisement engine suggests a price for first chair access to the reserved portion or non-reserved portion via the interface. The advertisement engine selects advertisements based on the profiles of the advertisement campaigns. The profiles indicate placement preferences for advertisements and whether a portion of the impression inventory is reserved or non-reserved for the advertisement campaigns. The advertisement engine may provide remnant portions of the impression inventory to an advertisement exchange that receives bids for accessing the impressions of the remnant portions.

### BACKGROUND

Conventionally, online advertisements are an important piece of the marketing campaigns and sales strategies of many businesses, including advertisers and content providers. To accommodate advertisers wishing to market goods or services online, web pages are often designed with salable content regions. These content regions can be configured to display advertisements to the end user upon navigating to the web pages.

These advertisements may be presented only if buyers that are associated with the advertisements purchase a particular number of display instances or impressions. A conventional advertisement delivery engine may be responsible for accepting the purchase orders and distributing the advertisements for display in the content regions of the web pages. These purchase orders may be included in advertisement campaigns created by the buyers. The advertisement campaigns may include direct buying campaigns. In a direct buying campaign, the buyer purchases a number of impressions on a publisher's webpage or within the publisher's multimedia content. The buyer speaks with a sales representative, who assists the buyer in developing the advertisement campaign.

One type of direct buying campaign may include guaranteed delivery of a number of impressions, referred to as a “reserved advertisement” campaign. A reserved advertisement campaign is guaranteed upon acceptance of the order by the conventional advertisement delivery engine. That is, the delivery engine commits to render the buyer's advertisements in the number of impressions specified in the “reserved advertisement” campaign.

For instance, if an advertiser, e.g., the buyer, places an order for one million impressions of a particular advertisement, acceptance of the order by the conventional advertisement delivery engine corresponds to an agreement that the delivery engine will cause each of the one million impressions to occur. If the delivery engine does not meet this obligation to present each of the one million impressions of the advertisement, or underdelivers, the buyer may experience dissatisfaction.

### SUMMARY

An advertisement platform provides an interface for programmatic buying of impressions. The impressions may be requested based on a publisher's available inventory or audience data developed by the publisher. The advertisement platform allows buyers to obtain first chair access to a publisher's inventory. The advertisement platform receives an indication of the reserved portions and the non-reserved portions of the inventory that are part of an advertisement campaign maintained by the buyers. Upon delivering and fulfilling purchased or guaranteed impressions, the advertisement platform may place remnant inventory into an advertisement exchange. In various embodiments, systems and method are provided for selecting advertisements for display within or along with an available impression.

This Summary is provided to introduce a selection of concepts in a simplified form that are further described below in the Detailed Description. This Summary is not intended to identify key features or essential features of the claimed subject matter, nor is it intended to be used as an aid, in isolation, in determining the scope of the claimed subject matter.

### BRIEF DESCRIPTION OF THE DRAWINGS

Embodiments of the invention are described in detail below with reference to the attached drawing figures, wherein:

FIG. 1 schematically shows a system environment suitable for performing embodiments of the invention;

FIG. 2 is a communications diagram illustrating delivery of advertisements in accordance with embodiments of the invention;

FIG. 3 is a block diagram that illustrates a programmatic interface in accordance with embodiments of the invention;

FIG. 4 is a logic diagram for managing impression that are made available for advertisements in accordance with embodiments of the invention; and

FIG. 5 is a logic diagram for building advertisement campaigns in accordance with embodiments of the invention.

### DETAILED DESCRIPTION

The subject matter of this patent is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step,” “block,” and/or “component,” etc., might be used herein to connote different components of methods or systems employed, the terms should not be interpreted as implying any particular order among or between various steps herein disclosed unless and except when the order of individual steps is explicitly described.

As utilized herein “first chair access” refers to allowing an advertiser to buy impressions by reserving a portion of the impressions in the publisher's inventory or allowing an advertiser to buy impressions included in the publisher's inventory without reserving a specific portion of the publisher's inventory. First chair access, also, gives a buyer priority access to an impression that satisfies criteria of the buyer's advertisement campaign.

As utilized herein “remnant inventory” refers to the remainder of the publisher's impression inventory that is not used by the advertisement campaigns.

Embodiments of the invention are directed to an application programming interface that aids in generating advertisement campaigns. The application programming interface is part of an advertisement engine. The application programming interface allows a buyer to obtain first chair access to advertisement impression inventory. In some embodiments, the buyer may reserve a portion of the inventory via the interface. The advertisement engine may provide a fixed programmatic price for each impression or collection of impressions in the inventory. The programmatic price may include the cost for establishing a reserved impression inventory for the buyer. This programmatic price differs from “haggle-based” buying or “auction-based” buying of impressions because the price is set by the advertisement engine in a take-or-leave fashion. The haggle-based buying involves back-and-forth negotiations between a buyer and sales personnel. The auction-based buying involves competing bidders that escalate the price for the impressions.

In some embodiments, the application programming interface of the advertisement engine may provide a buyer with several advertisement campaign building options. These include a request for proposal option, a browse-and-build option, a campaign objective option, or a human-assisted option. The request for proposal option allows a buyer to complete a form. The form is provided by the advertisement engine. The form allows the buyer to submit semi-structured data (e.g., the “I'd like to advertise the last couple of weeks of July, want most impressions above the fold, and have sky-scraper ads”). The form provides automation. The request is received via the application programming interface and processed by the advertisement engine. Accordingly, the form provided by the application programming interface allows the buyer to identify advertisements, to set a length of a campaign, to set a percentage or number of non-reserved inventory, to set a percentage or number of reserved inventory, and to identify the placement of the advertisements.

The browse-and-build option, in one embodiment, allows the buyer to browse offerings provided by the advertisement engine. The buyer selects from these offerings to create the advertisement campaign. The offerings include access to a publisher's impression inventory. This may include a number of impressions desired by the buyer. The offerings may also include the audience segment data provided by the publisher. The audience segment data explains preference information or behavioral information for the user that is currently browsing a digital asset associated with the publisher. Accordingly, the browse-and-build option, allows the buyer to reserve inventory and access impressions based on, among other things, audience data generated by the publishers.

In yet another embodiment, the campaign objective option allows the buyer to specify broad campaign objectives. For instance, the user may specify a length of the campaign and the desired audience segment. In turn, the advertisement engine recommends a campaign, the number of impressions across several categories, whether to reserve impressions, and the price of the campaign. In turn, the buyer may modify the campaign by removing impression categories, adding impression categories, or adding other criteria via the browse-and-build option of the interface.

The human-assisted option allows the buyer to interface directly with a sales representative, in some embodiments. The human-assisted option may completely bypass the automated features for building the advertisement campaign. Alternatively, the human assisted option may allow the buyer to obtain additional input on a campaign generated by the advertisement engine. The additional input may be received from the sales representative. Accordingly, the human-assisted option allows the buyer to bypass or augment the recommendations of the advertisement engine.

The buyer profile associated with the advertisement campaign is updated to reflect the recommendations of the advertisement engine or the requests made by the buyer. The buyer profile may include criteria associated with a reserved portion and whether the reserved impressions have been fulfilled. The buyer profile may also include an indication of whether the user accepted the programmatic price generated by the system. The buyer may be an advertiser or advertisement agency seeking to promote goods or services.

Having briefly described an overview of embodiments of the invention and some of the features therein, an exemplary operating environment suitable for implementing the present invention is described below.

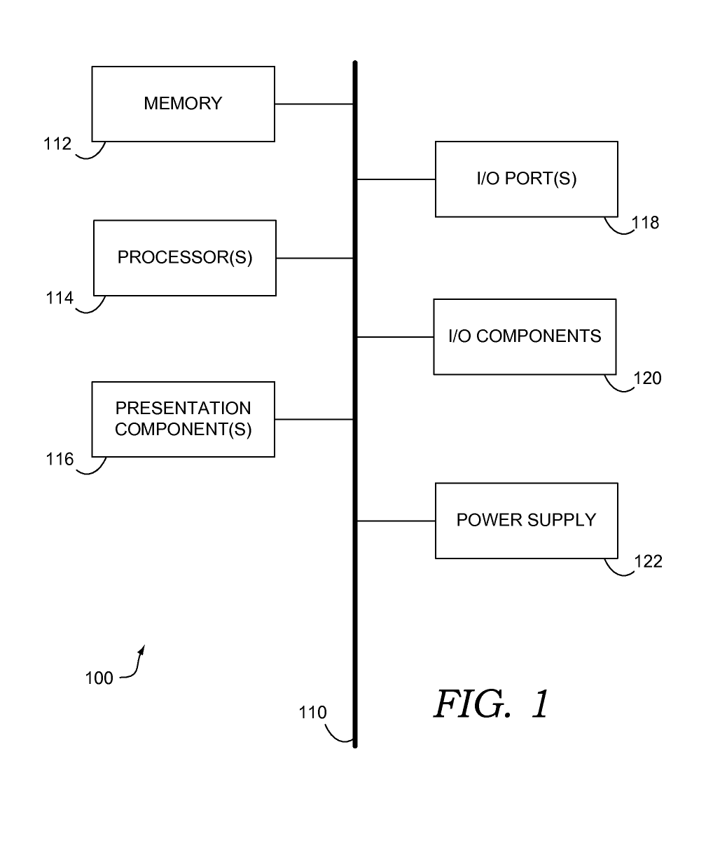

FIG. 1 schematically shows a system environment suitable for performing embodiments of the invention. Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The embodiments of the invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, tablet computers, consumer electronics, general-purpose computers, specialty computing devices, etc. Embodiments of the invention may also be practiced in distributed computing environments where tasks are performed by remote-processing devices that are linked through a cloud-based platform or communications network.

As one skilled in the art will appreciate, the computing device 100 may include hardware, firmware, software, or a combination of hardware and software. The hardware includes processors and memories configured to execute instructions stored in the memories. The logic associated with the instructions may be implemented, in whole or in part, directly in hardware logic. For example, and without limitation, illustrative types of hardware logic include field programmable gate array (FPGA), application specific integrated circuit (ASIC), system-on-a-chip (SOC), or complex programmable logic devices (CPLDs). The hardware logic allows the advertisement engine to select appropriate advertisements and to track pacing of advertisement campaigns. The pacing allows the advertisement engine to gauge how close an advertisement campaign is to fulfilling impressions guaranteed for the campaign. The computer device 100 may include the advertisement engine, which, in some embodiments, provides an application programming interface for building advertisement campaigns.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

The computing device 100 typically includes a variety of computer-readable media. Computer-readable media can be any available media that can be accessed by computing device 100 and includes both volatile and nonvolatile media, removable and non-removable media. Computer-readable media may comprise computer storage media. Computer storage media includes volatile and nonvolatile, removable and non-removable media implemented in any method or technology for storage of information such as computer-readable instructions, data structures, program modules or other data. Computer storage media includes, but is not limited to, Random Access Memory (RAM), Read Only Memory (ROM), Electronically Erasable Programmable Read Only Memory (EEPROM), flash memory or other memory technology, CD-ROM, digital versatile disks (DVD) or other holographic memory, magnetic cassettes, magnetic tape, magnetic disk storage or other magnetic storage devices, or any other medium that can be used to encode desired information and which can be accessed by the computing device 100. In an embodiment, the computer storage media can be selected from tangible computer storage media. In another embodiment, the computer storage media can be selected from non-transitory computer storage media. These memory technologies can store data momentarily, temporarily, or permanently.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components include a microphone, joystick, game pad, satellite dish, scanner, printer, wireless device, a controller, such as, a stylus, a keyboard and a mouse, or a natural user interface (NUI), etc. The NUI includes air gestures, voice, or other physiological inputs generated by a user. These inputs may be interpreted as requests for building an advertisement campaign or interacting with a web page by the computing device 100. These requests may be transmitted to the appropriate network element for further processing. The NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the user device 140 to render immersive augmented reality or virtual reality.

Various aspects of the technology described herein are generally employed in computer systems, computer-implemented methods, and computer-readable storage media for, among other things, managing impressions for a publisher advertisement impression inventory. The impressions are made available to buyers of the publisher's advertisement impression inventory. The impressions represent instances of a publisher's media content having an advertisement placeholder that should be filled in realtime as the user is requesting and loading the multimedia content on a computing device. Embodiments of the invention allow the advertisement engine to select an appropriate advertisement. The advertisements are selected from campaigns previously created by the advertisement engine in response to requests from buyers of the publisher's advertisement impression inventory.

In yet another embodiment, the computer system includes a communication network having a database, client computers, and a server. The database is configured to store the advertisement campaigns and advertisements for buyers. A user may request a web page or other multimedia content from a publisher's web domain. In turn, the advertisement server may execute an advertisement engine that selects an advertisement for delivery to the user. If an advertisement campaign has not requested or reserved the impression, the advertisement engine may obtain bids from the third parties, e.g., demand side platforms, via an advertisement exchange. The advertisement engine selects the highest bid that is consistent with the publisher's advertisement policy. In turn, the advertisement from the demand side platform is selected for delivery to the user. Accordingly, the advertisement engine selects the most appropriate advertisement based on the advertising campaigns associated with the buyers or bids received from an advertisement exchange when the advertisement campaigns fail to reserve access to the impression associated with the publisher's domain.

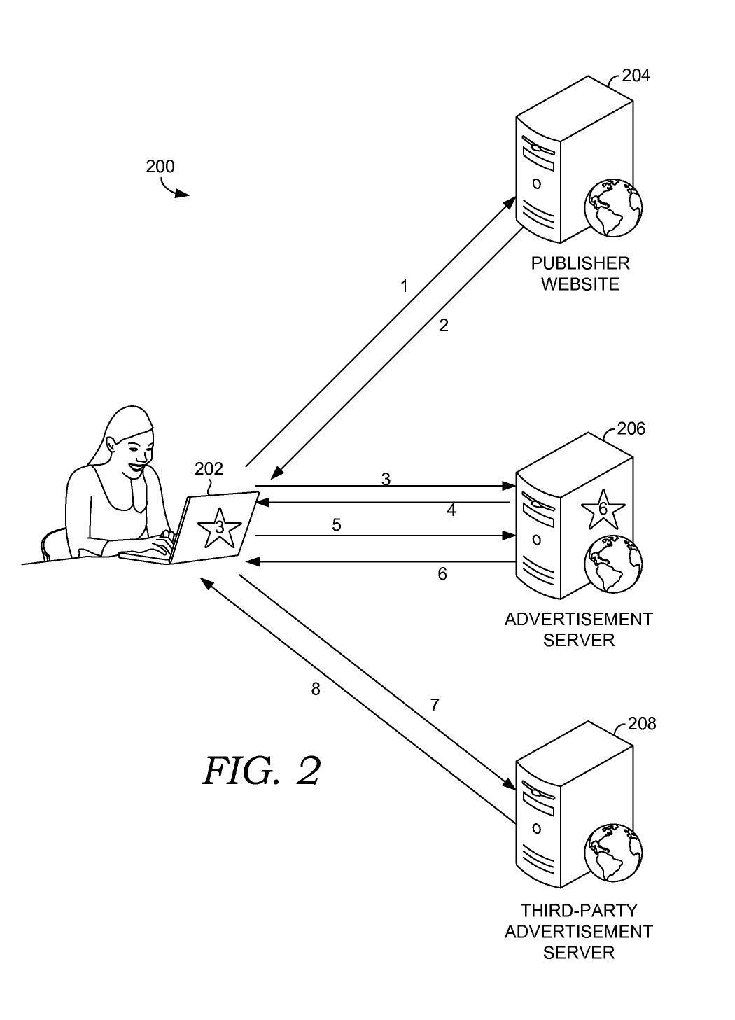

FIG. 2 is a communications diagram illustrating delivery of advertisements in accordance with embodiments of the invention. With reference now to FIG. 2, the delivery system 200 includes, among other things, a user computing device 202, a publisher server 204, an advertisement server 206, and a third-party advertisement server 208. An example of delivering an advertisement to the user computing device 202 in accordance with one embodiment of the invention is explained below. In the illustrated example, the publisher server 204 serves web pages or other multimedia content, e.g., video, audio, etc., from a publisher's website or web domain. For instance, the publisher's website may be the MSN® Auto website, www.autos.msn.com. The MSN® Auto website may include a number of locations for placing advertisements. Placement of advertisements on web pages from the website is directed by the advertisement server 206.

In some embodiments, the advertisement server 206 may be communicatively connected to the publisher website. In one embodiment, requests for any page from the MSN® Auto website may generate one or more impressions depending on the number of advertisements on the page or associated with a web page. The MSN® Auto website may have three advertisement placeholders. Thus, the request by the computing device for the MSN® Auto website may create three impressions. These impressions are made available to advertisement server 206. Because the publisher website may be requested by 100 or 1,000 computers at any given moment, the advertisement server 206 may create and manage publisher's advertisement impression inventory. The inventory may include 300 or 3,000 impressions that require advertisements.

The advertisement server 206 includes an advertisement engine that selects advertisements for delivery. The advertisement engine also builds advertisement campaigns that may have reservations for the publisher's advertisement impression inventory. These reservations may include, a desired audience, e.g., male less than 40, associated with MSN® Auto website. The reservations may also include the number of impressions reserved for the MSN® Auto website or the multimedia locations. For instance, one or more buyers may have set up advertisement campaigns that reserved 200 impressions each on the landing page of the MSN® Auto website. The advertisement engine selects an advertisement from the one or more advertisement campaigns that have reserved impressions for the landing page of the MSN® Auto website. In some embodiment, the buyers with reserved inventory in their advertisement campaign may have their advertisement displayed in the advertisement placeholders on the landing page of the MSN® to complete their campaign. The advertisement engine may select an impression from the one or more advertisement campaigns based on a value assigned to the impression. The values are determined, in one embodiment, based on the percent of completion for the campaign based on both number of impressions and time, e.g. length of campaign. The closer the campaign is to completion, e.g., 200 impressions on the landing page of the MSN® Auto website, the value assigned to the impression may be less compared to the value of the impression for an advertisement campaign for another buyer for the same impression or same number of impressions that is further away from completion. In certain embodiments, pacing goals are set for each advertisement campaign with reserved inventory or first chair access. These goals are used to value the impressions for each campaign. For instance, the value for impression to a campaign that is closer to the end of the campaign may be lower than the value for the same impression to a campaign that is further from the end of the campaign.

The advertisement engine selects advertisements first from the advertisement campaigns with reserved inventories based on their percent to completion. In turn, the advertisements from advertisement campaign with the lowest percentage may be selected for delivery. When all advertisement campaigns with reserved inventory to the publisher's advertisement impression inventory are complete, the advertisement campaigns having non-reserved inventory are allowed to access impression based on the corresponding percent to completion. When the advertisement campaign maintained by the advertisement engine have are exhausted or do not have an advertisement for an available impression, the advertisement engine communicates the impression to advertisement auctions that include third-party advertisement servers 208 that have advertisements for display.

Thus, the advertisement campaigns with first chair access, non-reserved impressions, or reserved impressions for the landing page of the MSN® Auto website are fulfilled before third-party access is allowed via the exchange and corresponding demand side platforms. The demand-side platform allows the third-party advertisement server 208 to bid on the impressions not used by the advertisement campaigns maintained by the advertisement engine of the advertisement server 206. In some instances, the advertisement engine may provide the third-party advertisement server 208 or demand side platform access to audience data associated with the impressions. The audience data may include search history, browsing history, or other information about the user computing device 202. In some embodiments, the user of the computing device 202 consents to sharing of this information. In other embodiments, the information is anonymized before sharing with third-parties via the advertisement exchange. In turn, the demand-side platform uses the anonymized information to allow the third-party advertising servers to bid on the corresponding impressions.

The advertisement engine selects the advertisement from the third-party advertisement server 208 that provided the highest bid when the advertisement is consistent with publisher's advertisement policy, e.g., no expletives, nudity, etc. The advertisement engine provides the user computing device 202 a link to the third-party advertisement. The link provides access to the selected advertisement on the third-party advertisement server 208.

As shown in FIG. 2, an individual may employ a web browser on the user computing device 202 to access the website from the publisher server 204. A request is communicated from the user computing device 202 to the publisher server 204 at step 1. The publisher server 204 responds with content for the website that includes a redirect for retrieval of the advertisements for the advertisement placeholders. The redirect that links to the advertisement server 206 and other publisher content is received at the user computing device 202 at step 2. The user computing device 202 begins to render the content received from the publisher server 204. While content is being rendered at the device 202, at step 3, the user computing device 202 opens a communication session to obtain the advertisements for the placeholders as instructed in the redirect. The advertisement server 206 receives the request from the user computer device 202. This request may include cookie information, in certain embodiments, that contain user search and browsing history, among other things. The advertisement server 206 selects an appropriate advertisement as discussed above based on the advertisement campaigns maintained by the advertisement engine of the advertisement server 206 or an advertisement auction. In turn, the advertisement server 206, at step 4, informs the user computer device of the location of the selected advertisement.

If the advertisement engine selects the advertisements from an advertisement campaign, the location of the selected advertisement may be the advertisement server 206. The user computing device 202, in step 5, requests the advertisement server 206 to deliver the identified advertisement to the placeholders on the user computing device 202. In step 6, the advertisement server 206 transmits the requested advertisements to the advertisement placeholders on the user computing device 202.

If the advertisement engine selects the advertisements from the advertisement exchange, the location of the selected advertisement may be a third-party server 208 as opposed to the advertisement server 206. The user computing device 202, in step 7, requests the third-party server 208 to deliver the identified advertisement to the placeholders. In step 8, the third-party server 208 transmits the requested advertisements to the advertisement placeholders on the user computing device 202. Accordingly, an appropriate advertisement is delivered to the user computing device 202 either from the advertisement campaigns maintained by the advertisement engine of the advertisement server 206 or from an advertisement exchange having third-party server 208 when the campaigns have not requested the impression available at the advertisement server 206.

In some embodiments, the advertisement engine includes a campaign booking engine and campaign recommendation engine. The campaign booking engine and campaign recommendation engine assist a buyer that intends to generate an advertisement campaign. The advertisement campaign may include programmatic pricing recommendations received from the advertisement engine. These recommendations may include pricing for reserved advertisement impression inventory for a publisher or pricing for first chair access to the reserved advertisement impression inventory.

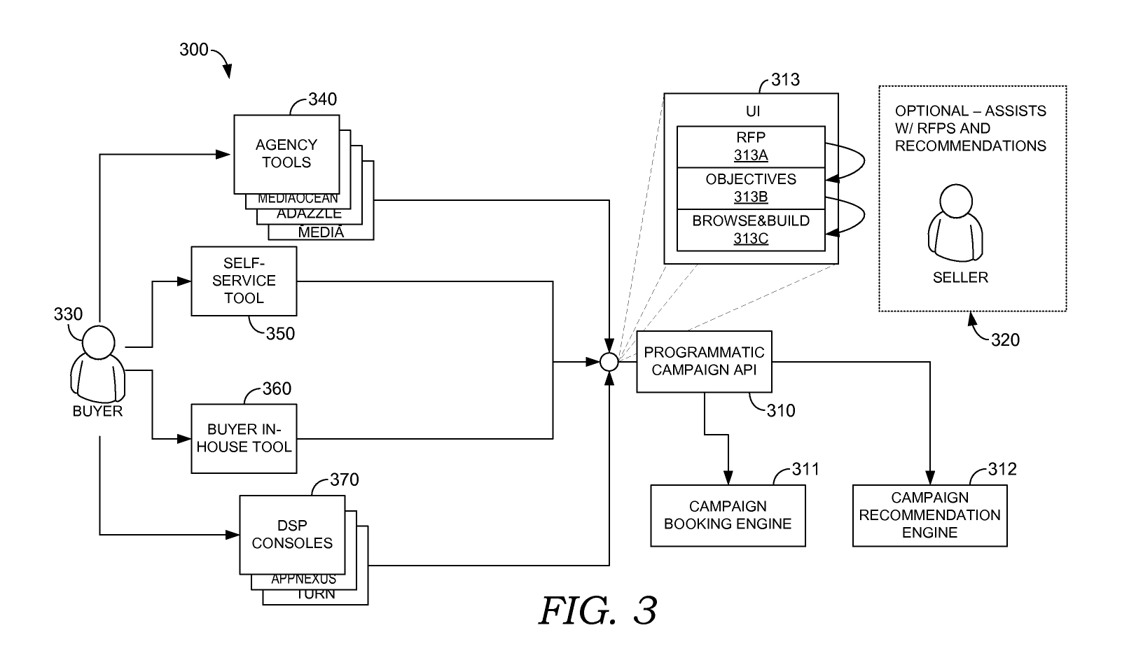

FIG. 3 is a block diagram that illustrates a programmatic interface 300 in accordance with embodiments of the invention. The advertisement engine of the advertisement server implements a programmatic interface 300. The programmatic interface 300 provides a user interface 313, in certain embodiments, which is used to manage or build advertisement campaigns. The programmatic interface 300 includes, among other things, a programmatic campaign application programming interface 310 that provides access to the campaign booking engine 311 and campaign recommendation engine 312.

The campaign booking engine 311 allows a buyer 330 or seller 320 to create or edit advertisement campaigns for the advertisement engine. The campaign booking engine may generate a user interface 313 that allows the user to specify the criteria for the advertisement campaign. The campaign booking engine 311 may receive criteria such as advertisement policy, campaign period, campaign budget, etc. The advertisement policy may proscribe the placement of the advertisement. For instance, the advertisement policy may restrict placement of advertisements to certain parts of the web page. In some embodiments, the policy may restrict the advertisements to placeholders that are visible without scrolling of web page or multimedia content that contains the placeholder. In further embodiments, the policy may prevent display of the advertisements on web pages having objectionable content, like expletives or nudity. The advertisement engine may check the multimedia content or web pages associated with the available impressions to confirm that the policy of the advertisement campaign is fulfilled.

The campaign booking engine 311, in certain embodiments, allows the buyer 330 or seller 320 to request non-reserved access or reserved access. Reserved access allows the advertisement campaign to have first access to each impression received by the advertisement engine that satisfies the conditions of the advertisement campaign. Reserved access may also allow the advertisement campaign to reserve a specific number of impressions before they are received. The advertisement engine allows the buyer or seller to establish a number of expected impressions for the advertisement campaign. The non-reserved access allows the advertiser to obtain and use impressions associated with the publisher before the impression is sent to an advertisement exchange.

In some embodiments, the advertisement campaign may include reservations for impression for specific websites, impressions across a web domain, or impression across audience segments. The impressions for a specific website may specify the number of impression for a website like the landing page of the MSN® Auto website The impressions across a web domain may specify the number of impression for any website within a domain like msn.com. The websites within the domain may include travel, home, auto, finance, etc. The impressions across audience segments may specify that any impressions that have user cookies or anonymized profiles showing recent interest, e.g., search history, browsing history, sales history, in a particular subject matter should receive an advertisement from the advertisement campaign. This allows the buyers or seller to access particular segments of the publisher's audience via the impressions without leaking specific user information or other private information by the advertisement engine. Accordingly, the buyer 330 or seller 320 may reserve inventory for a publisher's advertisement impression inventory.

The campaign recommendation engine 312, in some embodiments, provides suggestions for updating or developing the advertisement campaign. The campaign recommendation engine 312 may include recommended pricing information for campaigns that include reserved inventory or non-reserved inventory. The pricing of these campaigns may be non-negotiable up to a specific level of commitment. For instance, any campaign seeking to reserve 10 million impressions or more may require negotiation between a seller 320 and buyer 330.

In addition to the price, the campaign recommendation engine 312 may provide audience recommendations based on the subject matter of the campaign or the impressions for websites or web domains reserved for the advertisement campaign. The advertisement engine may analyze the reserved impressions and develop recommended audiences. For example, an advertisement campaign that reserved several football web domains or websites may obtain a recommendation from the campaign recommendation engine 312 to include soccer audience segments, NFL football audience segments, NCAA football audience segments, tailgating audience segments, or food audience segments. These recommendations may be based on the cookie information for a majority of users that visit the reserved football web domains or websites of the advertisement campaign. The recommendation may be included in the campaign when selected by the buyer 330 or seller 320.

In some embodiments, the seller 320 may use the programmatic interface 300 to develop or edit advertisement campaigns on behalf of a client. Also, a buyer 330 may utilize the programmatic interface 300 to develop or edit an advertisement campaign. The buyer, in some embodiments, may be an advertiser, an advertisement agency, a demand side platform, or an individual interested in access to reserved impression inventories for publishers that are associated with the advertisement engine.

In one embodiment, the advertisement engine generates a user interface 313 to allow graphical access to the functions provided by the programmatic application interface 300. The graphical user interface provides an RFP option 313A, an objective option 313B, or a browse-and-build option 313C. In other embodiments, the functions (RFP option 313A, an objective option 313B, or a browse and build option 313C, etc.) for the programmatic interface 300 may be accessed directly without the graphical user interface 313 via program calls initiated by other applications that have been granted access to the functions provided by the programming interface 300. The other applications may be graphical user interfaces or programs, like agency tools 340, self-service tools 350, buyer in-house tool 360, or consoles 370 for demand side platforms used by buyers 330.

As discussed above, the application programming interface 300 of the advertisement engine may provide a buyer 330 or seller 320 with several advertisement campaign building options. These include a request for proposal option 313A, a campaign objective option 313B, a browse-and-build option 313C, or a human-assisted option. The request for proposal option 313A allows a buyer to complete a form. The form is provided by the advertisement engine. The form allows the buyer to submit semi-structured data describing the scope of the advertisement campaign. The form provides automation for this request. The request is received via the application programming interface 300. Accordingly, the form provided by the application programming interface 300 allows the buyer 330 or seller 320 to identify the advertisements, to set the length of the campaign, to set the percentage or number of non-reserved inventory, to set the percentage or number of reserved inventory, and to identify the placement of the advertisements.

The campaign objective option 313B allows the buyer to specify broad campaign objectives. For instance, the buyer 330 or seller 320 may specify the length of the campaign and the desired audience segment. In turn, the campaign recommendation engine 312 suggests a campaign, number of impressions across several categories, whether to reserve impression, and the price of the campaign. In turn, the buyer 330 or seller 320 may modify the campaign by removing impression categories, adding impression categories, or adding other criteria via the browse-and-build option 313C of the interface.

The browse-and-build option 313C, in one embodiment, allows the buyer 330 or seller 320 to browse offerings provided by the advertisement engine. The buyer selects from these offering to create or modify the advertisement campaign. The offerings include access to a publisher's impression inventory. This may include a number of impressions desired by the buyer. The offerings may also include the audience segment data provided by the publisher. The audience segment data describes preference information or behavioral information for users that have browsed, or users that are currently browsing, a digital asset associated with the publisher. Accordingly, the browse-and-build option 313C, allows the buyer to reserve inventory and access impression based on audience data generated by the publishers.

The human-assisted option allows the buyer 330 to interface directly with a seller 320, in some embodiments. The human-assisted option may completely bypass the automated features for building the advertisement campaign. Alternatively, the human assisted option may allow the buyer 330 to obtain additional input on a campaign recommended by the recommendation engine 312. The additional input may be received from the seller 320, e.g., sales representative. In some embodiment, the seller 320 may be mandatory when the reserved amount is above a specific threshold. Accordingly, the human-assisted option allows the buyer to bypass or augment the automated recommendations of the advertisement engine.

In some embodiments, the advertisement engine is configured to manage access to impression inventory for publishers. The advertisement engine receives a request for an advertisement campaign from a buyer or seller. In turn, the advertisement engine may recommend a suggested price for various portions of the impression inventory. The buyer or seller may select the portion of the inventory at the suggested price. In turn, a profile associated with the campaign is updated to reflect the selection of inventory and the suggested price.

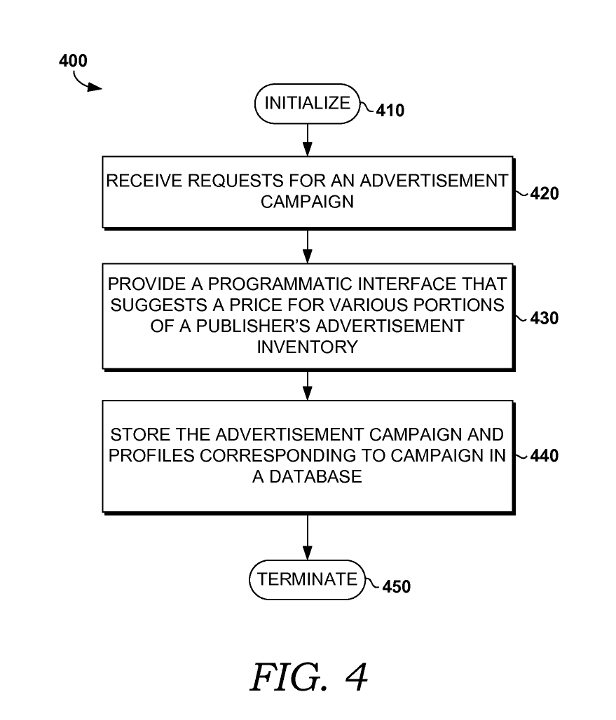

FIG. 4 is a logic diagram 400 for managing impressions that are made available for advertisements in accordance with embodiments of the invention. The advertisement engine is configured to manage impressions that are made available for advertisements. The advertisement engine includes a database and an advertisement campaign engine. The method initializes in step 410. The advertisement campaign engine receives, at step 420, requests to generate an advertisement campaign. In some embodiments, the advertisement campaign engine provides, in step 430, a programmatic interface that indicates a suggested price for various portions of an advertisement impression inventory for the advertisement campaign. In one embodiment, the suggested price includes a fee for a reserved portion of the advertisement impression inventory. A buyer or seller that is building the campaign may select portions of an advertisement impression inventory for inclusion in the advertisement campaign.

In step 440, the advertisement engine accesses a database to store the advertisement campaign and a profile corresponding to the campaign. The profile includes the specific portion selected by the buyer or seller and the price that corresponds to the selected portion. The profiles may, in some embodiments, specify the portion of the advertisement impression inventory that is reserved and whether first chair access is requested for the reserved portion.

The advertisement engine manages, in certain embodiments, the campaign based on a total budget set aside for the reserved portions of the impression inventory. Once the budget is spent, the advertisement engine marks the advertisement campaign as closed or finished. Alternatively, the advertisement engine manages the campaign based on the number of impressions desired by the buyer or seller. The advertisement engine may include an advertisement selection engine.

The advertisement selection engine obtains an advertisement from campaigns with reserved portions of the advertisement impression inventory. The advertisement selection may be configured to select advertisements based on one of the following: whether the number of impressions reserved for the campaign is within a percentage range of being fulfilled or whether the number of impressions reserved for the campaign is not within a percentage range of being fulfilled. For instance, the advertisement engine may continue to provide advertisements to a campaign having first chair access until it reaches 85% to 90% fulfilled. At this point, the advertisement engine may select other advertisements from campaigns that have not reached 85% to 90%. In some embodiments, this level is a moving threshold level. In other words, the initial level may be 40% for each campaign that seeks the same impressions. When each campaign reaches this level, the threshold moves up by 20% to 50%. This continues until all campaigns reach 100%. Additionally, the advertisement engine may verify that each campaign is at least at 50% after receiving a predetermined number of impressions, e.g., 200 million. For any campaign, not at 50%, the advertisement engine may select advertisements from the campaigns to bring them up to at least 50% complete when appropriate impressions become available. In some embodiments, if the advertisement engine is not receiving impression from its publishers, the advertisement exchange may be used to obtain additional impressions in real time to fulfill the reserved impressions for an advertisement campaign.

In other embodiments, when the advertisement engine is unable to locate advertisement campaigns with non-reserved access or reserved access to an impression, an appropriate advertisement is selected from real time advertisement auctions having one or more demand side platform bidders. The method terminates in step 450.

In further embodiments, the advertisement engine may receive requests for portions of a publisher's advertisement inventory. The advertisement engine may reserve the requested portions. In turn, an interface that inquires about the desirability of first chair access is generated. The interface may be updated based on the selection to show whether first chair access is desirable. A profile corresponding to the advertisement campaign stores an indication for the reserved portions and an indication for the desirability of first chair access.

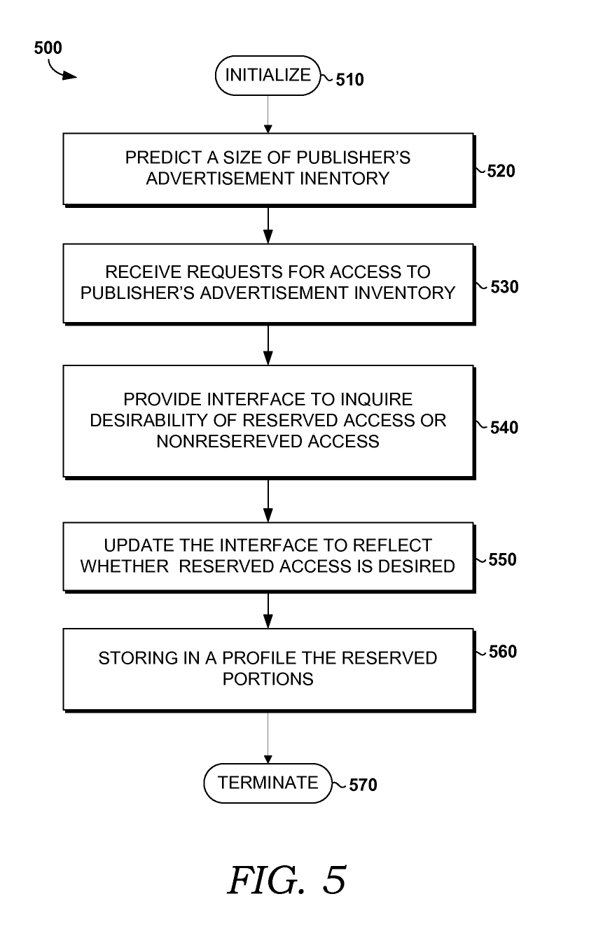

FIG. 5 is a logic diagram 500 for building advertisement campaigns in accordance with embodiments of the invention. The method initializes in step 510. The number of available impressions is predicted by the advertisement engine from log data associated with publisher, in step 520. The log data may include previous impressions from the publisher's web domain, third-party domains managed by the publisher, the publisher's advertisement funded clients associated with publisher, or the publisher's applications. The size is an estimate that is updated as impressions are received in realtime.

The advertisement engine, in step 530, receives a request for access to a publisher's available advertisement impression inventory, in certain embodiments. The request may specify audience data, e.g., age, gender, income, browsing history, search history, etc. of interest to an advertiser. In one embodiment, the request includes advertisements for an advertisement campaign corresponding to publisher's available advertisement impression inventory. The advertisements included in the request may comprise banner advertisements, rich media advertisements, video advertisements, text advertisements, image advertisements. In turn, an interface is provided by the advertisement engine to inquire whether reserved access or non-reserved access is desired for the advertisement impression inventory, in step 540.

In one embodiment, the advertisement engine may automatically specify prices for reserved access or non-reserved access to the advertisement impression inventory via the interface. The advertisement engine receives an indication via the interface that reserved access is desired for a portion of the available advertisement impression inventory. Upon acceptance of the pricing, the portion of the inventory is reserved for the advertisement campaign. In step 550, the interface is update to reflect that reserved access it desired for the portion of the advertisement impression inventory. The impressions, in some embodiments are associated with content from the publisher's web domain. The impressions are also associated with content from the publisher's advertisement funded clients or the publisher's applications and content from third-party domains managed by the publisher. Accordingly, the impressions may include web domains having webpages or other multimedia content.

In certain embodiments, the advertisement engine reserves a particular placement within the reserved portion. The particular placement may be a spatial or temporal placement within the reserved portion. The particular placement may be specified by a particular location (top, left, right, above the fold, etc.) within the reserved portion of the publisher's webpages. The particular placement audience location or audience behavior associated with the reserved portion of the publisher's inventory. The temporal placement may specify how long or how frequently to display advertisements. The temporal placement may specify a dwell time associated with the reserved portion of the publisher's inventory.

The advertisement engine stores the advertisement campaign in a database. In step 560, a profile is updated to store an indication of the reserved portion of the impression inventory corresponding to advertisement campaign. The advertisement engine selects advertisements from the reserved advertisement campaign and non-reserved advertisement campaigns. In some embodiments, the publisher may also have remnant inventory when the advertisement campaigns are exhausted or do not use an impression included in the inventory. The advertisement engine accesses the remnant portion of the advertisement inventory and provides the remnant portion to an advertisement exchange. The advertisement exchange performs real-time bidding for the remnant portion of publisher's impression inventory. In one embodiment, the remnant portion made available to the advertisement exchange includes targeting information that may be used by a demand side platform of the advertisement exchange. The bids provided by the demand side platform may be based on the targeting information associated with the remnant portion. The targeting information, in one embodiment, includes web cookies associated with the impressions of the unreserved portion. The method ends in step 570.

In summary, an advertisement engine is configured to build and manage advertisement campaigns. The advertisement campaigns are built via an application programming interface that provides access to a publisher's advertisement impression inventory. The inventory may be reserved and the advertisement campaign may request first chair access to impressions that fulfill the advertisement campaign criteria. In one embodiment, pricing is recommended for both reserved access and non-reserved access. The advertisement engine automates several of the advertisement building functions. In turn, the advertisement engine manages the selection of advertisements for available impressions. Accordingly, the advertisement engine is able to fairly select advertisements to from the advertisement campaigns to fulfill the reserved impressions.

Embodiments of the invention that have been described are intended in all respects to be illustrative rather than restrictive. Alternative embodiments will become apparent to those of ordinary skill in the art to which the invention pertains without departing from its scope. From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims.

The technology claimed is:

1. A computer-implemented method for building an advertisement campaign, the computer-implemented method comprising:
predict a size of a publisher's available advertisement impression inventory;
receiving a request for access to the publisher's available advertisement impression inventory;
providing an interface that inquires whether reserved access or non-reserved access is desired for the available advertisement impression inventory;
receiving an indication via the interface that a portion of the available advertisement impression inventory is reserved; and
updating a profile to include the reserved portion of the impression inventory.

2. The computer-implemented method of claim 1, wherein impressions are received in real time and are included in the advertisement impression inventory.

3. The computer-implemented method of claim 2, wherein the impressions are associated with content from the publisher's web domain.

4. The computer-implemented method of claim 2, wherein the impressions are associated with content from the publisher's advertisement funded clients or the publisher's applications.

5. The computer-implemented method of claim 2, wherein the impressions are associated with content from third-party domains managed by the publisher.

6. The computer-implemented method of claim 1, wherein requesting access includes providing advertisements that include banner advertisements, rich media advertisements, video advertisements, text advertisements, image advertisements.

7. The computer-implemented method of claim 2, wherein reserving the portion includes reserving a particular spatial or temporal placement within the reserved portion of the publisher's inventory.

8. The computer-implemented method of claim 7, wherein the particular placement specifies a specific location within the reserved portion of the publisher's inventory.

10. The computer-implemented method of claim 7, wherein the particular placement specifies audience location associated with the reserved portion of the publisher's inventory.

11. The computer-implemented method of claim 7, wherein the particular placement specifies audience behavior associated with the reserved portion of the publisher's inventory.

12. The computer-implemented method of claim 11, wherein the particular placement specifies a dwell time associated with the reserved portion of the publisher's inventory.

13. The computer-implemented method of claim 1, further comprising automatically specifying a price for access to the advertisement impression inventory via the interface.

14. A computer system for managing impressions that are made available for advertisements, the computer system comprising processors and memories configured to execute the following:
an advertisement campaign engine that receives requests to generate an advertisement campaign and that provides a programmatic interface that indicates a suggested price for various portions of an advertisement impression inventory for the advertisement campaign; and
a database that stores the advertisement campaign and a profile corresponding to the campaign, wherein the profile indicates the portion of the advertisement impression inventory that is reserved and whether first chair access is requested for the reserved portion.

15. The computer system of claim 14, wherein the campaign is managed based on a total budget set aside for the reserved portion of the impression inventory.

16. The computer system of claim 14, wherein the campaign is managed based on the number of impressions desired.

17. The computer system of claim 14, further comprising an advertisement selection engine that obtains an advertisement from campaigns having access to the advertisement impression inventory.

18. The computer system of claim 17, wherein the advertisement selection engine prefers advertisement campaigns that have reserved impression over advertisement campaigns that have non-reserved impressions, prefers advertisement campaigns with higher bids than advertisement campaigns with low bids, and prefers advertisement campaigns that are behind over advertisement campaigns that are ahead.

19. The computer system of claim 17, wherein the advertisement is selected based on one of the following: whether the number of impressions reserved for the campaign is within a percentage range of being fulfilled or whether the number of impressions reserved for the campaign is not within a percentage range of being fulfilled.

20. One or more computer storage media storing executable instructions for performing a computer-implemented method for building an advertisement campaign, the computer-implemented method comprising:
receiving a request for access to a publisher's available advertisement impression inventory based on audience data;
providing an interface that inquires whether reserved access or non-reserved access is desired for the available advertisement impression inventory;
specifying a price for access to the advertisement impression inventory via the interface;
indicating via the interface whether reserved access is desired for the available advertisement impression inventory; and
updating a profile to include a reserved portion of the inventory.
